(19) United States
(12) Patent Application Publication
(10) Pub. No.: US 2025/0209391 A1
(43) Pub. Date: Jun. 26, 2025

(54) SYSTEMS AND METHODS TO EFFICIENTLY NAVIGATE UNMANNED VEHICLES

(71) Applicant: DroneUp, LLC, Virginia Beach, VA (US)

(72) Inventors: Therese Rose CLEAVER, Chesapeake, VA (US); Remigiusz ZAJAC, Wroclaw (PL); Hunter WILLOUGHBY, San Diego, CA (US); John VERNON, Virginia Beach, VA (US)

(21) Appl. No.: 18/393,368

(22) Filed: Dec. 21, 2023

(51) Int. Cl. G06Q 10/0631; B64U 101/00

(52) U.S. Cl. CPC G06Q 10/063112; B64U 2101/00

(57) ABSTRACT

In an embodiment, a registration request is received for an operator from a plurality of operators and for a site having a set of site rules defining operational permissions for the site. The operator is associated with a skill indicator, an experience indicator for the site, and an experience indicator for at least one unmanned vehicle. An upper limit of unmanned vehicles for the operator is defined after the registration request of the operator is received and based on the set of site rules and at least one of the skill indicator associated with the operator, the experience indicator for the site and associated with the operator, or the experience indicator for the at least one unmanned vehicle and associated with the operator.

### FIELD

One or more embodiments are related to systems and methods to efficiently navigate unmanned vehicles (UVs).

### BACKGROUND

Operators can be tasked with operating UVs to complete various missions. It can be desirable for various reasons that operators are assigned a suitable number of UVs for completing these missions. For example, because different UV operators may have different levels of skill or experience, more skilled and/or more experienced operators operating more UVs can be more efficient from an operating perspective. As another example, given the high levels of stress reported amongst UV operators, assigning to each UV operator a suitable number of UVs for completing these missions can help to relieve that stress.

### SUMMARY

In an embodiment, a registration request is received for an operator from a plurality of operators and for a site having a set of site rules defining operational permissions for the site. The operator is associated with a skill indicator, an experience indicator for the site, and an experience indicator for at least one unmanned vehicle. An upper limit of unmanned vehicles for the operator is defined after the registration request of the operator is received and based on the set of site rules and at least one of the skill indicator associated with the operator, the experience indicator for the site and associated with the operator, or the experience indicator for the at least one unmanned vehicle and associated with the operator. A plurality of mission requests associated with the site is received. A plurality of unmanned vehicles is automatically assigned to the operator after receiving the plurality of mission requests and based on the set of site rules, the experience indicator for the site and associated with the operator, and the experience indicator for the at least one unmanned vehicle and associated with the operator. Each unmanned vehicle from the plurality of unmanned vehicles is assigned in response to a mission request from the plurality of mission requests. A number of unmanned vehicles in the plurality of unmanned vehicles does not exceed the upper limit of unmanned vehicles for the operator.

In an embodiment, an upper limit of unmanned vehicles for a first operator from a plurality of operators is defined based on (1) a set of site rules that is for a first site and that defines operational permissions for the first site and (2) at least one of a skill indicator associated with the first operator, the experience indicator for the first site and associated with the first operator, or the experience indicator for at least one unmanned vehicle and associated with the first operator. An upper limit of unmanned vehicles for a second operator from the plurality of operators is defined based on (1) a set of site rules that is for a second site and that defines operational permissions for the second site and (2) at least one of a skill indicator associated with the second operator, the experience indicator for the second site and associated with the second operator, or the experience indicator for at least one unmanned vehicle and associated with the second operator. A plurality of mission requests associated with the first site is received. A plurality of mission requests associated with the second site is received. A first plurality of unmanned vehicles is automatically assigned to the first operator based on (1) the set of site rules for the first site, and (2) at least one of a skill indicator associated with the first operator, the experience indicator for the first site and associated with the first operator, or the experience indicator for the at least one unmanned vehicle and associated with the first operator. Each unmanned vehicle from the first plurality of unmanned vehicles is automatically assigned in response to a mission request from the plurality of mission requests associated with the first site. A number of unmanned vehicles in the first plurality of unmanned vehicles does not exceed the upper limit of unmanned vehicles for the first operator. A second plurality of unmanned vehicles is automatically assigned to the second operator based on (1) the set of site rules for the second site, and (2) at least one of a skill indicator associated with the second operator, the experience indicator for the second site and associated with the second operator, or the experience indicator for the at least one unmanned vehicle and associated with the second operator. Each unmanned vehicle from the second plurality of unmanned vehicles is automatically assigned in response to a mission request from the plurality of mission requests associated with the second site. A number of unmanned vehicles in the second plurality of unmanned vehicles does not exceed the upper limit of unmanned vehicles for the second operator. The upper limit of unmanned vehicles for the first operator can be different from the upper limit of the unmanned vehicles for the second operator.

In an embodiment, an upper limit of unmanned vehicles for a first operator from a plurality of operators is defined based on (1) a set of site rules that is for a first site and that defines operational permissions for the first site and (2) at least one of a skill indicator associated with the first operator, the experience indicator for the first site and associated with the first operator, or the experience indicator for at least one unmanned vehicle and associated with the first operator. An upper limit of unmanned vehicles for a second operator from the plurality of operators is defined based on (1) a set of site rules that is for a second site and that defines operational permissions for the second site and (2) at least one of a skill indicator associated with the second operator, the experience indicator for the second site and associated with the second operator, or the experience indicator for at least one unmanned vehicle and associated with the second operator. A first plurality of unmanned vehicles is automatically assigned to the first operator based on (1) a plurality of mission requests associated with the first site, (2) role-based access control (RBAC) for the first operator, and (3) at least one of the skill indicator associated with the first operator, the experience indicator for the first site and associated with the first operator, or the experience indicator for the at least one unmanned vehicle and associated with the first operator. Each unmanned vehicle from the first plurality of unmanned vehicles is automatically assigned in response to a mission request from the plurality of mission requests associated with the first site. A number of unmanned vehicles in the first plurality of unmanned vehicles does not exceed the upper limit of unmanned vehicles for the first operator. A second plurality of unmanned vehicles is automatically assigned to the second operator based on (1) a plurality of mission requests associated with the first site, (2) RBAC for the second operator, and (3) at least one of the skill indicator associated with the second operator, the experience indicator for the second site and associated with the second operator, or the experience indicator for the at least one unmanned vehicle and associated with the second operator. Each unmanned vehicle from the second plurality of unmanned vehicles is automatically assigned in response to a mission request from the plurality of mission requests associated with the second site. A number of unmanned vehicles in the second plurality of unmanned vehicles does not exceed the upper limit of unmanned vehicles for the second operator. The set of site rules for the first site can be different from the set of site rules for the second site.

### BRIEF DESCRIPTION OF THE FIGURES

FIG. 1A shows a system block diagram for determining the upper limits for different operators, according to an embodiment.

FIG. 1B shows additional details related to mission assignor compute device, according to an embodiment.

FIG. 2 shows a flowchart of a method for assigning UVs to an operator, according to an embodiment.

FIG. 3 shows a flowchart of a method to assign unmanned vehicles to an operator that does not exceed a predefined upper limit for the operator, according to an embodiment.

FIGS. 4A-4B show a flowchart of a method to assign multiple unmanned vehicles to different operators having a different upper limits, according to an embodiment.

FIG. 5 shows a flowchart of a method to assign multiple unmanned vehicles different operators for different second sites having a different set of rules, according to an embodiment.

### DETAILED DESCRIPTION

Some implementations are related to determining an upper limit of vehicles (e.g., unmanned vehicles (UVs)) that a given operator can be assigned for a given site based on the operator's skill, experience with the site, experience with the vehicle, availability, role-based access control (RBAC), and/or the like. The upper limit can then be used to assign the operator missions and a number of UVs at the site that is less than and/or equal to the upper limit. By assigning an upper limit, the risk of operators being overburdened and overworked is mitigated. In turn, operators can operate UVs better (e.g., more efficient missions, less accidents, etc.).

For example, a delivery service may request an operator. The operator can be tasked with completing missions using UVs at or within a site(s) associated with the delivery service, such as aerially delivering packages from the delivery service's warehouse to houses of the delivery service's customers within a given neighborhood. Depending on rules associated with the site (e.g., local or state air traffic laws, mandatory quiet hours, maximum UV size or weight, etc.), the operator's skill (e.g., overall experience flying UVs, seniority, fitness level, test scores, operating record, etc.), the operator's experience with the specific site (e.g., number or duration of prior missions at the site, number of successful prior missions at the site, number of prior missions at sites with similar geography and/or topography, etc.), the operator's experience with the UV make and/or model (e.g., experience controlling aerial UVs, experience controlling fixed-wing drones, experience controlling single-rotor helicopter drones, experience controlling large UVs, experience controlling small UVs, etc.), the operator's availability (e.g., the operator is currently online, the operator is scheduled for work for a particular shift, etc.), the operator's RBAC (e.g., the operator is a UV pilot, the operator is a UAV pilot, the operator has a role that allows them access to operate a UV, etc.), and/or the like, an upper limit is assigned to the operator. The upper limit can indicate the maximum number of aerial UVs the operator can be assigned for completing missions at the site. For example, if the upper limit is five, the operator is assigned no more than five UVs at the same time and/or within a given time period for conducting a mission(s).

Thus, for a given operator, the operator's upper limit can vary depending on factors such as the site, the operator's skill, the operator's experience with a site, the operator's experience with a given type (e.g., make or model) of UV, the operator's availability, the operator's RBAC, and/or the like. Therefore, for example, the upper limit for an operator at one site can be different than the upper limit for the operator at a different site. As another example, the upper limit for a first operator at a given site can be different than the upper limit for a second, different operator at the same site. As another example, the upper limit for an operator at a site can be different than the upper limit for the operator at the same site (e.g., depending on the UV being used, availability, RBAC, a change in skill or experience, etc.).

In some implementations, techniques described herein can be performed with minimal human intervention and/or without human intervention. As a result, missions can be completed much faster and upper limits for operators can be determined much faster. Given that UVs can operate thousands of missions daily and each operator has dozens of characteristics unique to them, it can be inefficient and/or impractical for a human(s) to determine upper limits and/or assign missions.

In some implementations, techniques described herein are related to assigning a more optimal number of UVs to a given operator. This allows UVs to be more efficiently used. For example, if an operator is not assigned enough UVs, the operator may overly rely on assigned UVs to perform missions or not be able to complete missions together. As another example, if an operator is assigned too many UVs, the operator may be overwhelmed or UVs may stay unused waiting for assignment to and operation by an operator.

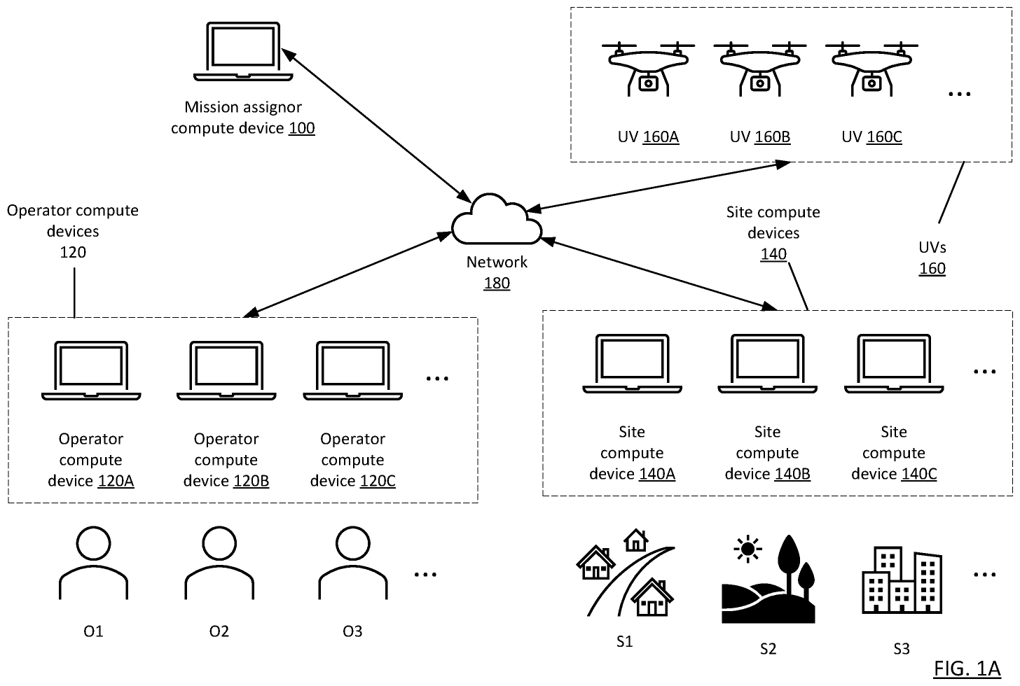

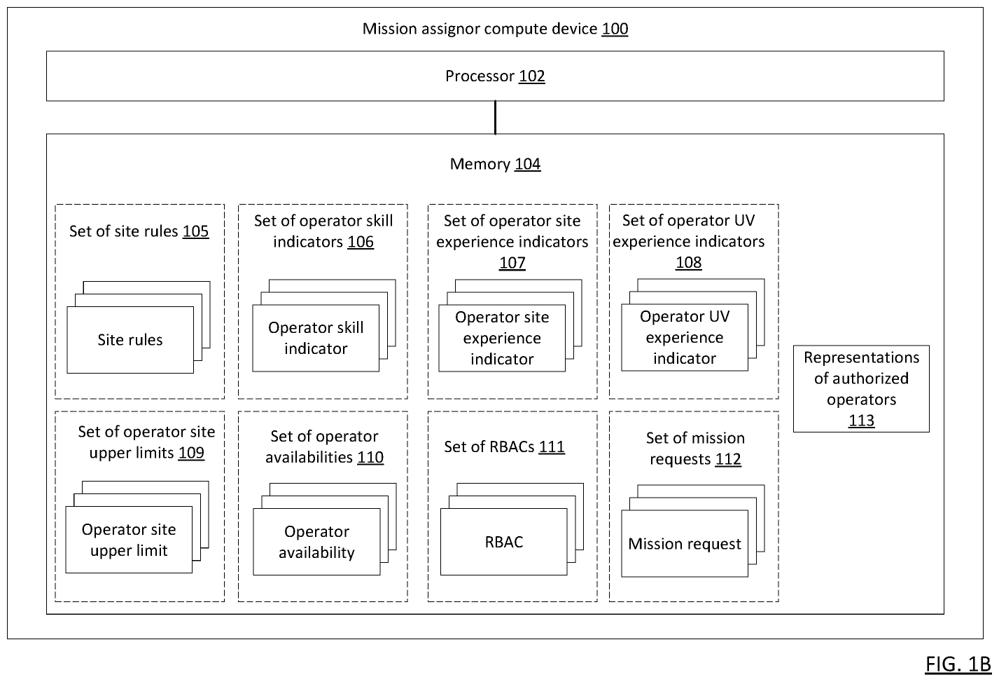

FIG. 1A shows a system block diagram for determining the upper limits for different operators, according to an embodiment. FIG. 1A includes mission assignor compute device 100, operator compute devices 120, site compute devices 140, and UVs 160, each communicatively coupled to one another via network 180.

In some implementations, a site compute device from site compute devices 140 associated with a site sends a registration request (e.g., to mission assignor compute device 100 or operator compute devices 120) requesting an operator for the site. Mission assignor compute device 100 can determine, for the operator, an upper limit of UVs that operator can be assigned at the site. Mission assignor compute device 100 can also determine, in response to mission requests from the site compute device 140, how many UVs the operator is assigned (e.g., at any given moment or time period) to complete the mission requests without exceeding that operator's associated upper limit. In some implementations, in response to a registration request, mission assignor compute device 100 can also confirm that the requested operator is authorized to perform missions and/or authorize the requested operator to perform missions.

Operator compute devices 120 can include any number of operator compute devices, such as operator compute devices 120A, 120B, 120C, and/or the like. Operator compute devices 120 can include any type of compute device, such as a desktop, laptop, tablet, phone, and/or the like. Although not explicitly shown in FIG. 1A, each operator compute device in operator compute devices 120 can include a processor and memory. Additionally, in some implementations, each operator compute device in operator compute devices 120 can include an output device such as a display (e.g., to display data received from a UV) and/or input device(s) (e.g., keyboard and mouse to control a UV).

Each operator compute device in operator compute devices 120 can be associated with (e.g., owned by, operated by, in the name of, accessible by, logged in using a profile of, etc.) an operator. For example, operator compute device 120A is associated with operator O1, operator compute device 120B is associated with operator O2, operator compute device 120C is associated with operator O3, and so on. An operator can be, for example, a person (human). Operators O1, O2, O3 can be, for example, a UV pilot or systems operator tasked with operating and/or monitoring a UV(s).

UVs 160 can include any number of UVs, such as UVs 106A, 106B, 106C, and/or the like. In some implementations, UVs 160 are unmanned (e.g., no human is aboard the UV). In some implementations, UVs 160 are operated by one or more operators via the operator compute devices 120. For example, UV 160A can be controlled by operator O1 via operator compute device 120A over network 180, UV 160B can be controlled by operator O2 via operator compute device 120B over network 180, and/or UV 160C can be controlled by operator O3 via operator compute device 120C over network 180. UVs 160 can include any type of UV, such as an aerial UV, water UV, or ground UV. Examples of UVs 160 include semi-autonomous cars, manual cars, radio-controlled carts, radio-controlled aircraft, unmanned combat aerial vehicles, medium-altitude long-endurance unmanned aerial vehicles, miniature unmanned aerial vehicle (UAVs), delivery drones, micro air vehicles, target drones, spaceport drone ships, surface drones, underwater vehicles, uncrewed spacecrafts, and/or the like. In some implementations, each UV in UVs 160 is a UAV.

Although not explicitly shown in FIG. 1A, each UV in UVs 160 can include a processor and memory. In some implementations, each UV in UVs 160 includes a camera and/or other sensors to track that UV's surroundings for consideration by the operator when operating that UV. In some implementations, UVs in UVs 160 have limited processing and/or memory capability due to, for example, a low weight requirement, a compact size requirement, and/or the like, and thus are operated remotely by operator compute devices 120.

Site compute devices 140 can include any number of site compute devices, such as site compute devices 140A, 140B, 140C, and/or the like. Site compute devices 140 can include any type of compute device, such as a desktop, laptop, tablet, phone, and/or the like. Although not explicitly shown in FIG. 1A, each site compute device in site compute devices 140 can include a processor and memory.

Each site compute device in site compute devices 140 can be associated with (e.g., requests missions for, be authorized to request missions for, etc.) a site. For the example shown in FIG. 1A, site compute device 140A is associated with site S1, site compute device 140B is associated with site S2, site compute device 140C is associated with site S3, and so on. In some implementations, a site compute device requests an operator(s) from operators 120 to use a UV(s) from UVs 160 to perform one or more missions at the associated site.

Although not explicitly shown in FIG. 1A, each site compute device in site compute devices 140 can include a processor and memory. Additionally, in some implementations, each site compute device in site compute devices 140 can include an output device such as a display and an input device(s) (e.g., keyboard and mouse to request a mission or operator).

The site can be any area, such as but not limited to a country, a state, a city, a neighborhood, a campus, a building, a body of water, and/or the like. In some implementations, a site refers to an area that a UV can access. Sites can have any type of geography, such mostly wooded, mostly urban, mostly flat, mostly hilly, and/or the like. Site can have any size and shape, such as a seven mile radius around a store, one mile radius within a warehouse, an entire city, and/or the like.

Mission assignor compute device 100 can be any type of compute device, such as a server, desktop, laptop, tablet, phone, and/or the like. Mission assignor compute device 100 can determine upper limits for operators. Mission assignor compute device 100 can assign UVs and missions to operators via operator compute devices 120 in response to mission requests from site compute devices 140 based on the determined upper limits.

In some implementations, site compute devices 140 can send registration requests (e.g., to mission assignor compute device 100 and/or operator compute devices 120) for operators operating operator compute devices 120. In response to a given registration request for a site and operator, mission assignor compute device 100 can determine the upper limit of UVs an operator can operate at the site, as well as how many UVs the operator is actually assigned when the operator is assigned a mission. Thereafter, the registered operator can operate a number of UVs less than (or not more than) the upper limit at the site to complete the mission.

In some implementations, mission assignor compute device 100 can authorize, in response to a registration request for an operator, that the operator is authorized to perform missions, is authorized to perform missions at the site, and/or the like. For example, for missions that need to be performed by operators having security clearances, mission assignor compute device 100 ensure that only operators with security clearances can conduct such missions.

FIG. 1B shows additional details related to mission assignor compute device 100, according to an embodiment. Mission assignor compute device 100 includes processor 102 operatively coupled to memory 104 (e.g., via a system bus).

Memory 104 includes (e.g., stores) a representation of set of site rules 105. Set of site rules 105 can indicate site rules for sites (e.g., sites S1, S2, S3) associated with site compute devices 140. The site rules at one site can be the same as or different than the site rules for a different site. For example, in some implementations, site S1 can be associated with first site rules, site S2 can be associated with second site rules different than the first site rules, and site S3 can be associated with third site rules different than the first and second site rules. Site rules from set of site rules 105 can represent any rules or laws that are relevant for operating UVs at a given site. Examples of site rules include restricted zones, minimum height or depth, maximum height or depth, operating hours, restricted UV types, allowed UV types, traffic rules, maximum capacity, speed limits, and/or the like. As an example, site rules for site S1 can indicate that aerial UVs are to fly at least 400 meters above the ground unless the UV is above a predesignated landing zone. As another example, site rules for site S2 can indicate that UVs are to enter through a designated entrance at site S2 and exit through a designated exit before dusk.

Memory 104 includes (e.g., stores) representations of authorized operators 113. Representations of authorized operators 113 can indicate those operators that are authorized to perform missions generally and/or those operators that are not authorized to perform missions generally for specific sites. For example, mission assignor compute device 100 can be configured to authorize operators who have a remote pilot certificate to operate missions at certain sites and not operators without a remote pilot certificate. As another example, mission assignor compute device 100 can be configured to let operators having a security clearance operate missions at certain sites and not operators without a security clearance. In some implementations, in response to mission assignor compute device 100 receiving a registration request for an operator, mission assignor compute device 100 can confirm that the operator is authorized by referencing representations of authorized operators 113.

Memory 104 also includes (e.g., stores) a representation of set of operator skill indicators 106. Set of operator skill indicators 106 can indicate skill levels of operators. Each operator skill indicator in set of operator skill indicators 106 can indicate a skill level of an associated operator. For example, a first operator skill indicator from set of operator skill indicators 106 can indicate a skill level of operator O1, a second operator skill indicator from set of operator skill indicators 106 can indicate a skill level of operator O2, and a third operator skill indicator from set of operator skill indicators 106 can indicate a skill level of operator O3. Different operators can have the same skill and/or different skill. Examples of operator skill indicators include a score within a predetermined range, a grade, a tier, and/or the like. In some implementations, each operator skill indicator included in set of operator skill indicators 106 indicates skill using a common scale (e.g., all operators are graded using the same criteria/grading system). A given operator's operator skill indicator could be for example based on any type of factor relevant for indicating skill level, such as number of successful missions, overall operating experience, test scores, and/or the like.

Memory 104 also includes (e.g., stores) a representation of set of operator site experience indicators 107. Set of operator site experience indicators 107 can indicate experience levels at sites for operators. In some implementations, each operator site experience indicator from set of operator site experience indicators 107 indicates a given user's experience (e.g., number of missions, overall duration of missions, complexity of missions, type of missions, characteristics of missions, and/or the like) at a given site. For example, a first operator site experience indicator can indicate operator O1's experience at site S1, a second operator site experience indicator can indicate operator O1's experience at site S2, a third operator site experience indicator can indicate operator O1's experience at site S3, a fourth operator site experience indicator can indicate operator O2's experience at site S1, a fifth operator site experience indicator can indicate operator O2's experience at site S2, a sixth operator site experience indicator can indicate operator O2's experience at site S3, a seventh operator site experience indicator can indicate operator O3's experience at site S1, an eighth operator site experience indicator can indicate operator O3's experience at site S2, and a ninth operator site experience indicator can indicate operator O3's experience at site S3.

Memory 104 also includes (e.g., stores) a representation of set of operator UV experience indicators 108. Set of operator UV experience indicators 108 can indicate operators' experience with certain types of UVs (e.g., the makes and/or models of UVs included in UVs 160). In some implementations, each operator UV experience indicator from set of operator UV experience indicators 108 indicates a given operator's experience (e.g., number of missions, overall duration of missions, complexity of missions, type of missions, characteristics of missions, and/or the like) for a given type of UV. A given operator can have different UV experience indicators for different UVs. In some implementations, the more experience an operator has with a type of UV, the better the associated operator UV experience indicator for that operator and that type of UV. For example, if operator O1 has operated thousands of missions using single-rotor helicopter drones but no missions using fixed-wing drones, the operator UV experience indicator for single-rotor helicopter drones can be better (e.g., higher) than the operator UV experience indicator for fixed-wing drones. Examples of types of UVs include aerial UVs, water UVs, and ground UVs. Additional examples of types of UVs include semi-autonomous cars, manual cars, radio-controlled carts, radio-controlled aircraft, unmanned combat aerial vehicles, medium-altitude long-endurance unmanned aerial vehicles, miniature UVs, delivery drones, micro air vehicles, target drones, spaceport drone ships, surface drones, underwater vehicles, uncrewed spacecrafts, multi-rotor drones, fixed-wing drones, single-rotor helicopter drones, fixed-wing hybrid VTOL drones, and/or the like.

To provide an example, if UV 160A is an aerial UV and UVs 160B and 106C are ground UVs, a first operator UV experience indicator can indicate operator O1's experience with aerial UVs, a second operator UV experience indicator can indicate operator O1's experience with ground UVs, a third operator UV experience indicator can indicate operator O2's experience with aerial UVs, a fourth operator UV experience indicator can indicate operator O2's experience with ground UVs, a fifth operator UV experience indicator can indicate operator O3's experience with aerial UVs, and a sixth operator UV experience indicator can indicate operator O3's experience with ground UVs.

Memory 104 also includes (e.g., stores) a representation of set of operator availabilities 110. Set of operator availabilities 110 can indicate each operator's availability. The operator's availability can be indicated using, for example, an online status indicator, offline status indicator, do not disturb status indicator, calendar, scheduled working hours, and/or the like. For example, operator availability for operator O1 can indicate that operator O1 is currently online, operator availability for operator O2 can indicate that operator O2 is currently offline, and operator availability for operator O3 can indicate that operator O3 is currently online but on do not disturb status. As another example, operator availability for operator O1 can indicate that operator O1 is currently online and scheduled to remain online until 5 PM ET, operator availability for operator O2 can indicate that operator O2 is currently offline and schedule to go online at 4:45 PM ET, and operator availability for operator O3 can indicate that operator O3 is currently offline and will remain offline until next week.

Memory 104 also includes (e.g., stores) a representation of set of RBACs 111. Set of RBACs 111 can indicate each operator's role and/or their access control. For example, set of RBCAs 111 can indicate that operators O1, O2, O3 are each UV pilots with permission/access to operator UVs 160. As another example, set of RBACs 111 can indicate that operators O1 and O2 are UAV pilots with permission/access to operate UAVs, while operator O3 is a ground UV pilot with permission/access to operate ground UVs. Additionally or alternatively, set of RBACs 111 can indicate what operators are registered at what sites. An operator can be registered at a site in response to the site compute device associated with that site requesting registration of the operator. For example, set of RBACs 111 can indicate that operator O1 received a registration request for (and thus has permission to perform missions at) sites S1 and S2 but not site S3, operator O2 received a registration request for (and thus has permission to perform missions at) sites S2 and S3 but not site S1, and operator O3 received a registration request for (and thus has permission to perform missions at) sites S1, S2, and S3. In some implementations, receiving a registration request for an operator from a site compute device associated with a site indicates that the operator has permission to conduct missions at that site, but does not indicate that the operator has permissions to conduct missions at other sites; for that operator to get permission to conduct missions at those other sites, those other sites must request/register (e.g., via their site compute device) that operator.

Memory 104 also includes (e.g., stores) a representation of set of operator site upper limits 109. Set of operator site upper limits 109 can indicate operators' maximum number of UVs they can be assigned for operating a mission(s) at different sites. In some implementations, an operator site upper limit from set of operator site upper limits 108 indicates, at a given moment, the maximum number of UVs that can be assigned to a given user for operating a mission(s) at a given site.

Set of operator site upper limits 109 can be generated based on set of site rules 105, set of operator skill indicators 106, set of operator site experience indicators 107, set of operator UV experience indicators 108, set of operator availabilities, set of RBACs 111, and/or the like. In some implementations, a machine learning model (not shown in FIG. 1A or 1B) can be trained using site rules, operator skill indicators, operator site experience indicators, operator UV experience indicators, operator availabilities, RBACs, operator site upper limits, and/or the like. For example, site rules, operator skill indicators, operator site experience indicators, operator UV experience indicators, operator availabilities, and/or RBACs can be used as input learning data and associated operator site upper limits can be used as output/target learning data.

In some implementations, output provided by the machine learning model can be used to retrain the machine learning model. For example, an operator's performance (e.g., number of successful machines, standby time waiting for UVs, delay time, etc.) can be tracked compared to the operator site upper limits output by a machine learning model, and used to retrain the machine learning model. Thus, over time, the machine learning can be more accurate in producing operator site upper limits.

In some implementations, set of operator site upper limits 109 is generated without consideration of at least one of set of site rules 105, set of operator skill indicators 106, set of operator site experience indicators 107, set of operator UV experience indicators 108, set of operator availabilities, or set of RBACs 111. By limiting the amount of data that mission assignor compute device 100 considers when calculating set of operator site upper limits 109, assignor compute device 100 can calculate set of operator site upper limits 109 faster.

To provide an example, set of operator site upper limits 109 may indicate that: operator O1's upper limit is operating five UVs at site S1, three UVs at site S2, and two UVs at site S3; operator O2's upper limit is operating three UVs at site S1, four UVs at site S2, and six UVs at site S3; and operator O3's upper limit is operating ten UVs at site S1, twelve UVs at site S2, and six UVs at site S3.

In some implementations, factors that could increase an operator's operator site upper limit could include site rules favoring more UVs (e.g., site has a large capacity such as a rural site without many obstacles), higher operator skill, higher operator site experience, higher operator UV experience, desirable operator availability (e.g., operator is online and scheduled to remain online), desirable RBAC (e.g., operator's role has access, operator is registered at the site), and/or the like. In some implementations, factors that could decrease an operator's operator site upper limit could include site rules disfavoring more UVs (e.g., site has a small capacity such an urban site with many obstacles), lower operator skill, lower operator site experience, lower operator UV experience, undesirable operator availability (e.g., operator is offline and scheduled to remain offline), undesirable RBAC (e.g., operator's role doesn't have access, operator is not registered at the site, etc.), and/or the like.

Memory 104 also includes (e.g., stores) a representation of set of mission requests 112. Set of mission requests 112 can be received at mission assignor compute device 100 from site compute devices 140. A mission request can request a registered operator(s) to operate a mission using a UV(s). Examples of missions includes transporting an object (e.g., package, human, etc.) to or from a destination, gathering certain data (e.g., weather data, video, images, etc.), performing a repair, acquiring a resource, and/or the like.

Mission assignor compute device 100 can assign registered operators and/or UVs for operating set of mission requests 112. When assigning UVs to an operator, mission assignor compute device 100 can assign UVs based on site rules for the site associated with the mission (e.g., indication of the site rules included in set of site rules 105), the operator's skill (e.g., indication of the operator's operator skill indicator included in set of operator skill indicators 106), the operator's experience indicator for the site associated with the mission (e.g., indication of the operator's experience indictor for the site associated with the mission included in set of operator site experience indicators 107), the operator's experience indicator for the UV (e.g., indication of the operator's experience indicator for the UV included in set of operator UV experience indicators 108), the operator's availability (e.g., indication of the operator's availability included in set of operator availabilities 110), the operator's RBACs (e.g., indication of the operator's RBAC included in set of RBACs 111), and/or the like.

Additionally, in some implementations, mission assignor compute device 100 can assign UVs to operators so that a given operator is not assigned a number of UVs larger than the operator's site upper limit (e.g., indication of the operator's site upper limit included in set of operator site upper limits 109). Additionally, in some implementations, mission assignor compute device 100 can assign UVs to operators so that a given operator is not assigned a number of UVs equal to or larger than the operator's site upper limit (e.g., indication of the operator's site upper limit included in set of operator site upper limits 109).

In some implementations, UVs are assigned to an operator for a predetermined period of time. For example, for an operator whose upper limit at a site is five UVs, mission assignor compute device 100 may assign the operator less than five UVs for no more than two hours. The predetermined period of time can be determined based on the operator's availability, as indicated in set of operator availabilities 110. In some implementations, set of operator availabilities 110 indicates how long an operator is scheduled to work, and the operator is assigned UVs for only the operator's scheduled work hours.

In some implementations, in response to a communication failure between a UV(s) and an operator compute device tasked with completing a mission using the UV(s), the mission and/or access to operate the UV(s) can be transferred to a different operator(s). The communication failure can be between the operator compute device and a single UV or multiple UVs (e.g., all UVs assigned to the operator compute device). In some instances, if a communications link (e.g., base station, network provider, etc.) between a given operator's compute device and a given UV becomes inoperable, the UV can be connected to the same operator and/or a different operator via a different communications link (e.g., via a different base station or a different network provider). In some instances, operator compute device not working (e.g., broken, turned off, unable to access the internet, malfunctioning, etc.) can cause the communication failure between that compute device and a UV; in such a scenario, in some implementations, a different operator/operator compute device (e.g., operating at the same site or operating at a different site) can be assigned to operate the UV.

In some implementations, the UV(s) being transferred to the different operator(s) does not cause that operator(s) to operate a number of UVs equal to and/or larger than their upper limit. In some implementations, who the different operator is can be determined based on set of operator availabilities 110 (e.g., an operator who is online) and/or set of operator site upper limits 109 (e.g., the operator being assigned another UV won't cause that operator's upper limit to pass). In some implementations, the different operator is not determined based on set of operator site experience indicators 107 and/or set of operator UV experience indicators 108. In some implementations, the different operator can be determined based on set of RBACs 111 (e.g., an operator who is registered for the site of the mission). To provide one example, if a first operator compute device cannot operate a UV due to a communication failure, a second operator compute device can be assigned to operate the UV; the second operator compute device can be selected based on the operator of the second operator compute device's availability (e.g., second operator is available) and/or upper limit (e.g., being assigned the UV won't cause the second operator's upper limit to be surpassed), but not the second operator site experience indicator and/or UV experience indicator.

In some implementations, set of site rules 105, set of operator skill indicators 106, set of operator site experience indicators 107, set of operator UV experience indicators 108, set of operator site upper limits 109, set of operator availabilities 110, set of RBACs 111, set of mission requests 112, and/or representations of authorized operators 113 is updated repeatedly (e.g., sporadically, periodically, etc.). This can enable mission assignor compute device 100 to produce more accurate and precise data, such as more suitable set of operator site upper limits 109. For example, as operators gain more experience and skill, set of operator skill indicators 106, set of operator site experience indicators 107, and/or set of operator UV experience indicators 108 can update to reflect the operators' increased experience and skill. Additionally, as data is updated, the prior data (that is being replaced by the updated data) can be deleted (e.g., to save memory), saved at memory 104, and/or sent to a different compute device.

In one example, site compute device 140A requests registration of an operator by sending an electronic signal(s) to mission assignor compute device 100 and/or an operator compute device from operator compute device 120A. The operator is associated with an operator skill indicator, operator site experience indicator for site S1, operator UV experience indicator, operator availability, and/or the like. After the operator has been registered, mission assignor compute device 100 can determine an upper limit for the operator—that maximum number of UVs the operator can be assigned to operate at site S1. Thereafter, in response to a mission request by site compute device 140A, mission assignor compute device 100 can assign the operator a number of UVs from UVs 160 that is less than the operator's upper limit at site S1.

To provide another example, site compute device 140B requests registration of operators by sending an electronic signal(s) to mission assignor compute device 100 and/or an operator compute device(s) from operator compute devices 120. The operators are each associated with an operator skill indicator, operator site experience indicator for site S2, operator UV experience indicator, operator availability, and/or the like. After the operators have been registered, mission assignor compute device 100 can determine upper limits for each of operator—that maximum number of UVs each of operators can be assigned to operate at site S2. Thereafter, in response to a mission request by site compute device 140B, mission assignor compute device 100 can assign the operators a number of UVs from UVs 160 that is less than each operator upper limit at site S2.

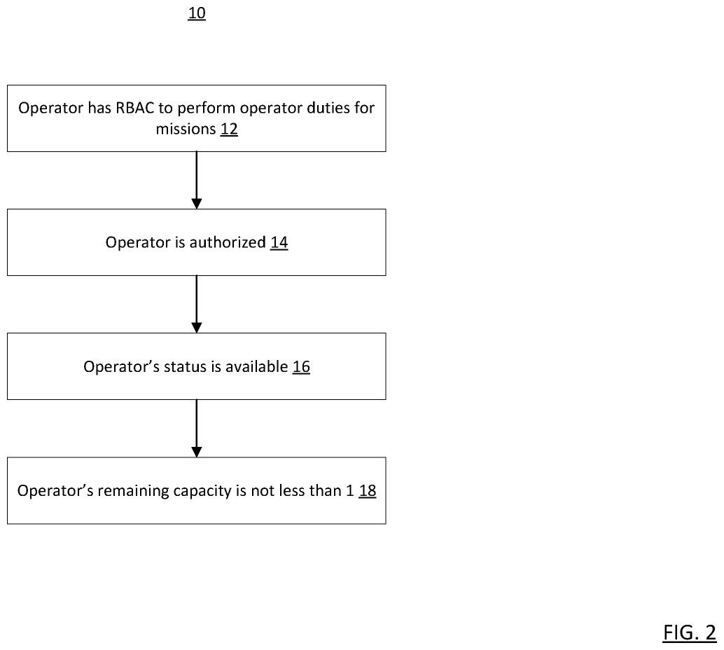

FIGS. 1 and 2 illustrate just one example, and variations can exist. Any number of upper limits for any number of operators can be assigned by any number of mission assignor compute devices for any number of sites and any type of UV. For example, mission assignor compute device can determine upper limits for hundreds of different operators and hundreds of different sites.

Additionally, techniques described herein are not limited to UVs. For example, upper limits can be determined for operators operating manned vehicles.

Additionally, site rules, operator skill indicators, operator site experience indicators, operator UV experience indicators, operator availabilities, and/or RBACs are just some factors that can be considered for determining upper limits. Any other relevant factor that can be useful for determining a desirable upper limit of UVs an operator should operate can also and/or alternatively be considered (e.g., by mission assignor compute device 100).

In some implementations, mission assignor compute device 100 operates as a system-as-a-service for site compute devices 140 to register users and request missions. For example, users at site compute devices 140 may create a profile that allows them to log in and request services (e.g., user registration, mission requests, etc.) from mission assignor compute device 100.

Network 180 can be any suitable communications network for transferring data, operating over public and/or private networks. For example, a network can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, network 180 can be a wireless network such as, for example, a Wi-Fi or wireless local area network (“WLAN”), a wireless wide area network (“WWAN”), and/or a cellular network. In other instances, network 180 can be a wired network such as, for example, an Ethernet network, a digital subscription line (“DSL”) network, a broadband network, and/or a fiber-optic network. In some instances, the network can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS)). The communications sent via the network can be encrypted or unencrypted. In some instances, network 180 can include multiple networks (e.g., a combination of wireless and wired networs) or subnetworks operatively coupled to one another by, for example, network bridges, routers, switches, gateways and/or the like.

In some implementations, network 180 is a private network. Thus, for example, only certain devices (such as those shown in FIG. 1A) can communicate via network 180. Using a private network can provide more security for, for example, controlling UVs 160. Since missions can often be critical, using a private network can prevent undesirable cyber-attacks.

FIG. 2 shows a flowchart of a method 10 for assigning UVs to an operator, according to an embodiment. In some implementations, method 10 is performed by a processor (e.g., processor 102).

At 12, a check is made to determine whether the operator has role-based access control (RBAC) to perform operator duties for missions. For example, at 12, in response to a registration request for a site, the operator may have been given RBAC to perform operator duties for missions at that site. An operator receiving RBAC can be indicated in set of RBACs 111. Thus, in some implementations, mission assignor compute device (e.g., mission assignor compute device 100) can perform 12 using set of RBACs 111. In response to the determination at 12 that the operator has RBAC to perform operator duties, at 14, a check is made to determine whether the operator (e.g., representations of operators 113) is authorized for the site. In response to the determination at 14 that the operator is authorized for the site, at 16, the operator's status is checked to determine if the operator is available (e.g., using set of operator availability 110). In response to the determination at 16 that the operator's status indicates availability, at 18, the number of UVs already assigned to the operator is compared to the operator's upper limit (e.g., as indicated by set of operator site upper limits 109). If the operator has capacity to operate another drone (e.g., the current number of drones operated by the operator is less than the operator's upper limit), the operator is assigned another UV and/or another mission. Method 10 is one example, and in other implementations, method 10 can be performed for any number of operators, missions, UVs, sites, and/or the like over any period of time.

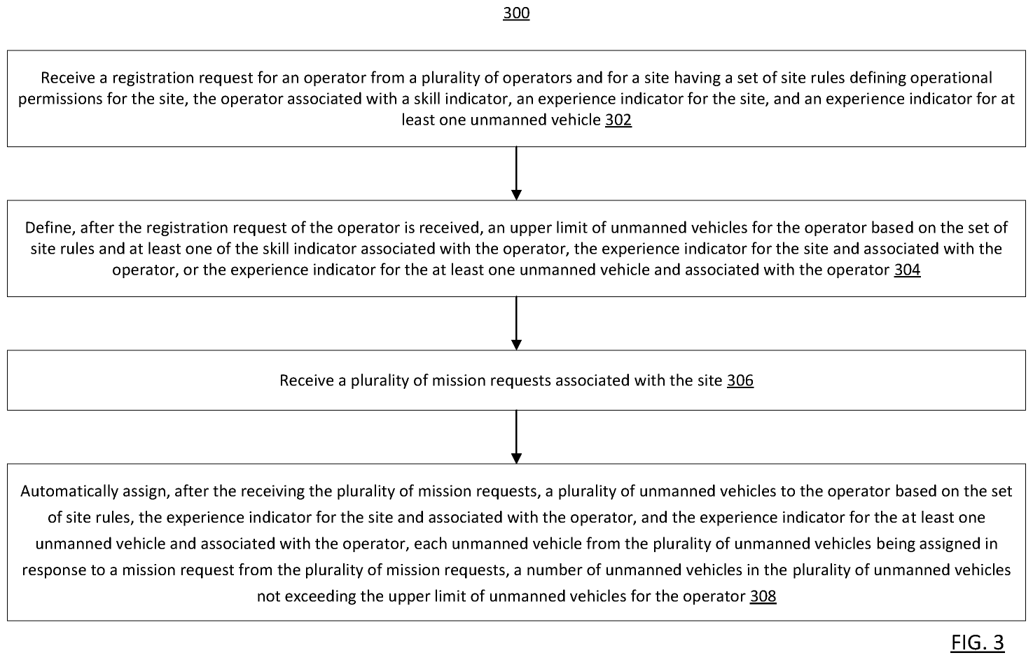

FIG. 3 shows a flowchart of a method 300 to assign unmanned vehicles to an operator that does not exceed a predefined upper limit for the operator, according to an embodiment. In some implementations, method 300 is performed by a processor (e.g., processor 102).

At 302, a registration request is received (e.g., at mission assignor compute device 100 and from site compute device 140A) for an operator (e.g., operator O1) from a plurality of operators (e.g., operators O1, O2, O3) and for a site (e.g., site S1) having a set of site rules (e.g., included in set of site rules 105) defining operational permissions for the site. The operator is associated with a skill indicator (e.g., included in set of operator skill indicators 106), an experience indicator for the site (e.g., included in set of operator site experience indicators 107), and an experience indicator for at least one unmanned vehicle (e.g., included in set of UV experience indicators 108).

At 304, an upper limit of unmanned vehicles for the operator is defined (e.g., included in set of operator site upper limits 109) after the registration request of the operator is received at 302 and based on the set of site rules and at least one of the skill indicator associated with the operator, the experience indicator for the site and associated with the operator, or the experience indicator for the at least one unmanned vehicle and associated with the operator.

At 306, a plurality of mission requests (e.g., included in set of mission requests 112) associated with the site is received (e.g., at mission assignor compute device 100 and from site compute device 140A).

At 308, a plurality of unmanned vehicles (e.g., UVs included in UVs 160) is automatically (e.g., without human intervention) assigned to the operator after receiving the plurality of mission requests at 306 and based on the set of site rules, the experience indicator for the site and associated with the operator, and the experience indicator for the at least one unmanned vehicle and associated with the operator. Each unmanned vehicle from the plurality of unmanned vehicles is assigned in response to a mission request from the plurality of mission requests. A number of unmanned vehicles in the plurality of unmanned vehicles does not exceed the upper limit of unmanned vehicles for the operator.

In some implementations of method 300, the operator is a first operator, the site is a first site included within a plurality of site, and the plurality of unmanned vehicles is a first plurality of unmanned vehicles. Some implementations of method 300 further include automatically (e.g., without human intervention) authorizing the first operator for the first site and not for remaining sites (e.g., sites S2 and S3) from the plurality of sites. Some implementations of method 300 further include receiving a registration request for a second operator (e.g., operator O2) from the plurality of operators and associated with a second site that is from the plurality of sites and that has a set of site rules (e.g., included in set of site rules 105) defining operational permission for the second site. Some implementations of method 300 further include automatically authorizing, after the registration request for the second operator is received, the second operator for a second site (e.g., site S2) from the plurality of sites and not remaining sites (e.g., site S1 and S3) from the plurality of sites.

In some implementations of method 300, the operator is a first operator. Some implementations of method 300 further include automatically (e.g., without human intervention) assigning a second plurality of unmanned vehicles to a second operator (e.g., operator O2) from the plurality of operators. In some implementations, a number of unmanned vehicles in the second plurality of unmanned vehicles does not exceed an upper limit of unmanned vehicles for the second operator. In some implementations, the upper limit of unmanned vehicles for the first operator is different from the upper limit of unmanned vehicles for the second operator.

In some implementations of method 300, the operator is a first operator, the site is a first site included within a plurality of sites (e.g., sites S1, S2, S3), and the plurality of unmanned vehicles is a first plurality of unmanned vehicles. Some implementations of method 300 further include receiving a registration request for a second operator (e.g., operator O2) from the plurality of operators and associated with a second site (e.g., site S2) that is from the plurality of sites and that has a set of site rules (e.g., included in set of site rules 105) defining operational permission for the second site. Some implementations of method 300 further include automatically (e.g., without human intervention) assigning a second plurality of unmanned vehicles to the second operator. In some implementations, a number of unmanned vehicles in the second plurality of unmanned vehicles does not exceed an upper limit of unmanned vehicles for the second operator. In some implementations, the set of site rules for the first site differ from set of site rules for the second site.

In some implementations of method 300, assigning the plurality of unmanned vehicles to the operator at 308 is further based on role-based access control (RBAC) (e.g., included in set of RBACs 111) for the operator and an availability (e.g., included in set of operator availabilities 110) of the operator.

In some implementations of method 300, the site is included within a plurality of sites (e.g., sites S1, S2, S3). Some implementations of method 300 further include automatically (e.g., without human intervention) authorizing, after receiving the registration request at 302, the operator for the site and not for remaining sites (e.g., sites S2, S3) from the plurality of sites. Some implementations further include, assigning, after the operator has been authorized, the plurality of unmanned vehicles to the operator further based on role-based access control (RBAC) (e.g., included in set of RBACs 111) for the operator.

In some implementations of method 300, the site is included within a plurality of sites (e.g., sites S1, S2, S3). Some implementations of method 300 further include automatically (e.g., without human intervention) authorizing, after receiving the registration request at 302, the operator for the site and not for remaining sites (e.g., sites S2 and S3) from the plurality of sites. Some implementations further include assigning, after the operator has been authorized, the plurality of unmanned vehicles to the operator during a time period when the operator is available to operate the plurality of unmanned vehicles.

In some implementations of method 300, the operator is a first operator. Some implementations of method 300 further include receiving an indication of communication failure between a compute device (e.g., operator compute device 120A) of the first operator and a first unmanned vehicle (e.g., UV 160A) from the plurality of unmanned vehicles assigned to the first operator. Some implementations of method 300 further include automatically (e.g., without human intervention), in response to the receiving the indication of communication failure, reassigning the first unmanned vehicle to a second operator (e.g., operator O2) based on an availability (e.g., included in set of operator availabilities 110) of the second operator and not based on an experience indicator (e.g., included in set of operator site experience indicators 107) for the site and associated with the second operator. In some implementations, the number of unmanned vehicles assigned to the second operator after the first unmanned vehicles is reassigned to the second operator does not exceed an upper limit of unmanned vehicles for the second operator.

In some implementations of method 300, the operator is a first operator. Some implementations of method 300 further include receiving an indication of communication failure between a compute device (e.g., operator compute device 120A) of the first operator and each unmanned vehicle from the plurality of unmanned vehicles assigned to the first operator. Some implementations of method 300 further include automatically (e.g., without human intervention), in response to the receiving the indication of communication failure, reassigning the plurality of unmanned vehicles to at least one operator other than the first operator based on an availability of the at least one operator and not based on an experience indicator for the site and associated with the at least one operator. A number of unmanned vehicles assigned to each operator from the at least one operator after the plurality of unmanned vehicles is reassigned and does not exceed an upper limit of unmanned vehicles for each operator from the at least one operator.

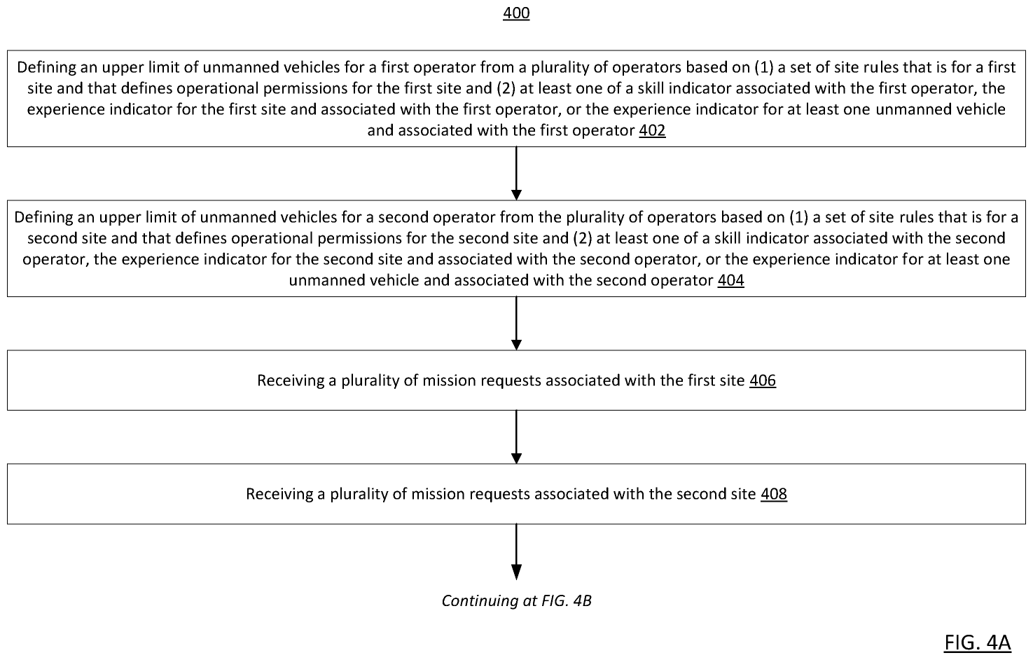

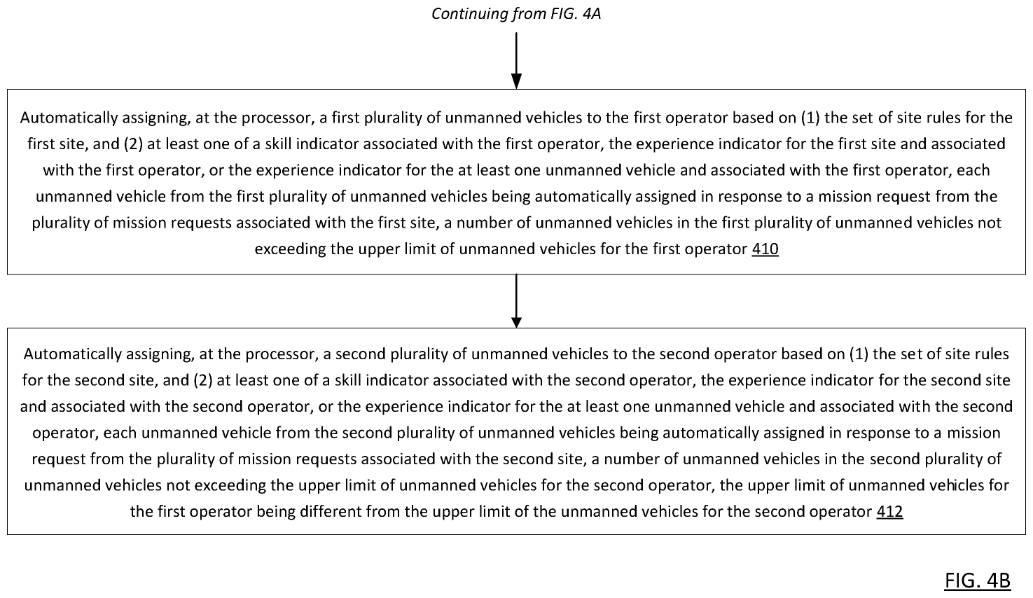

FIGS. 4A-4B show a flowchart of a method 400 to assign multiple unmanned vehicles to different operators having a different upper limits, according to an embodiment. In some implementations, method 400 is performed by a processor (e.g., processor 102).

At 402, an upper limit (e.g., for inclusion in set of operator site upper limits 109) of unmanned vehicles for a first operator (e.g., operator O1) from a plurality of operators (e.g., operators O1, O2, O3) is defined based on (1) a set of site rules (e.g., included in set of site rules 105) that is for a first site (e.g., site S1) and that defines operational permissions for the first site and (2) at least one of a skill indicator (e.g., included in set of operator skill indicators 106) associated with the first operator, the experience indicator (e.g., included in set of operator site experience indicators 107) for the first site and associated with the first operator, or the experience indicator (e.g., included in set of operator UV experience indicators 108) for at least one unmanned vehicle and associated with the first operator.

At 404, an upper limit (e.g., for inclusion in set of operator site upper limits 109) of unmanned vehicles for a second operator (e.g., operator O2) from the plurality of operators is defined based on (1) a set of site rules (e.g., included in set of site rules 105) that is for a second site (e.g., site S2) and that defines operational permissions for the second site and (2) at least one of a skill indicator (e.g., included in set of operator skill indicators 106) associated with the second operator, the experience indicator (e.g., included in set of operator site experience indicators 107) for the second site and associated with the second operator, or the experience indicator (e.g., included in set of operator UV experience indicators 108) for at least one unmanned vehicle and associated with the second operator.

At 406, a plurality of mission requests (e.g., included in set of mission requests 112) associated with the first site is received.

At 408, a plurality of mission requests (e.g., included in set of mission requests 112) associated with the second site is received.

At 410, a first plurality of unmanned vehicles (e.g., from UVs 160) is automatically (e.g., without human intervention) assigned to the first operator based on (1) the set of site rules for the first site, and (2) at least one of a skill indicator associated with the first operator, the experience indicator for the first site and associated with the first operator, or the experience indicator for the at least one unmanned vehicle and associated with the first operator. Each unmanned vehicle from the first plurality of unmanned vehicles is automatically assigned in response to a mission request from the plurality of mission requests associated with the first site. A number of unmanned vehicles in the first plurality of unmanned vehicles does not exceed the upper limit of unmanned vehicles for the first operator.

At 412, a second plurality of unmanned vehicles (e.g., from UVs 160) is automatically (e.g., without human intervention) assigned to the second operator based on (1) the set of site rules for the second site, and (2) at least one of a skill indicator associated with the second operator, the experience indicator for the second site and associated with the second operator, or the experience indicator for the at least one unmanned vehicle and associated with the second operator. Each unmanned vehicle from the second plurality of unmanned vehicles is automatically assigned in response to a mission request from the plurality of mission requests associated with the second site. A number of unmanned vehicles in the second plurality of unmanned vehicles does not exceed the upper limit of unmanned vehicles for the second operator. The upper limit of unmanned vehicles for the first operator can be different from the upper limit of the unmanned vehicles for the second operator.

Some implementations of method 400 further include receiving a registration request for the first operator. Some implementations of method 400 further include automatically (e.g., without human intervention) authorizing, after the registration request for the first operator is received, the first operator for the first site and not for remaining sites (e.g., sites S2 and S3) from the plurality of sites. Some implementations of method 400 further include receiving a registration request for the second operator. Some implementations of method 400 further include automatically (e.g., without human intervention) authorizing, after the registration request for the second operator is received, the second operator for the second site and not remaining sites (e.g., sites S1 and S3) from the plurality of sites.

In some implementations of method 400, the set of site rules for the first site is different from the set of site rules for the second site.

In some implementations of method 400, automatically assigning the first plurality of unmanned vehicles to the first operator at 410 includes automatically assigning the first plurality of unmanned vehicles to the first operator further based on role-based access control (RBAC) (e.g., included in set of RBACs 111) for the first operator. In some implementations of method 400, automatically assigning the second plurality of unmanned vehicles to the second operator at 412 includes automatically assigning the second plurality of unmanned vehicles to the second operator further based on RBAC (e.g., included in set of RBACs 111) for the second operator.

In some implementations of method 400, automatically assigning the first plurality of unmanned vehicles to the first operator at 410 includes automatically assigning the first plurality of unmanned vehicles to the first operator further based on an availability (e.g., included in set of operator availabilities 110) of the first operator. In some implementations of method 400, automatically assigning the second plurality of unmanned vehicles to the second operator at 412 includes automatically assigning the second plurality of unmanned vehicles to the second operator further based on an availability (e.g., included in set of operator availabilities 110) of the second operator.

Some implementations of method 400 further includes receiving (e.g., from site compute device 140A) a registration request for the first operator. Some implementations of method 400 further include automatically (e.g., without human intervention) authorizing, after the registration request for the first operator is received, the first operator for the first site and not for remaining sites (e.g., sites S2 and S3) from the plurality of sites. Some implementations of method 400 further include receiving (e.g., from site compute device 140B), a registration request for the second operator. Some implementations of method 400 further include automatically (e.g., without human intervention) authorizing, after the registration request for the second operator is received, the second operator for the second site and not remaining sites (e.g., sites S1 and S3) from the plurality of sites. In some implementations of method 400, automatically assigning the first plurality of unmanned vehicles to the first operator at 410 includes automatically assigning, after the first operator has been authorized, the first plurality of unmanned vehicles to the first operator further based on role-based access control (RBAC) (e.g., included in set of RBACs 111) for the first operator and an availability (e.g., included in set of operator availabilities 110) of the first operator. In some implementations of method 400, automatically assigning the second plurality of unmanned vehicles to the second operator at 412 includes automatically assigning, after the second operator has been authorized, the second plurality of unmanned vehicles to the second operator further based on role-based access control (RBAC) (e.g., included in set of RBACs 111) for the second operator and an availability (e.g., included in set of operator availabilities 110) of the second operator.

In some implementations of method 400, the mission request from the plurality of mission requests associated with the first site is a first mission request. Some implementations of method 400 further include receiving (e.g., from site compute device 140A), a registration request for a third operator (e.g., operator O3). Some implementations of method 400 further include defining an upper limit (e.g., to be included in set of operator site upper limits) of unmanned vehicles for the third operator from the plurality of operators based on the set of site rules for the first site. Some implementations of method 400 further include automatically (e.g., without human intervention) assigning a third plurality of unmanned vehicles to the third operator based on the set of site rules for the first site. Each unmanned vehicle from the third plurality of unmanned vehicles is automatically assigned in response to a second mission request (e.g., included in set of mission requests 112) from the plurality of mission requests associated with the first site. A number of unmanned vehicles in the third plurality of unmanned vehicles does not exceed the upper limit of unmanned vehicles for the third operator and is different from the number of unmanned vehicles in the first plurality of unmanned vehicles.

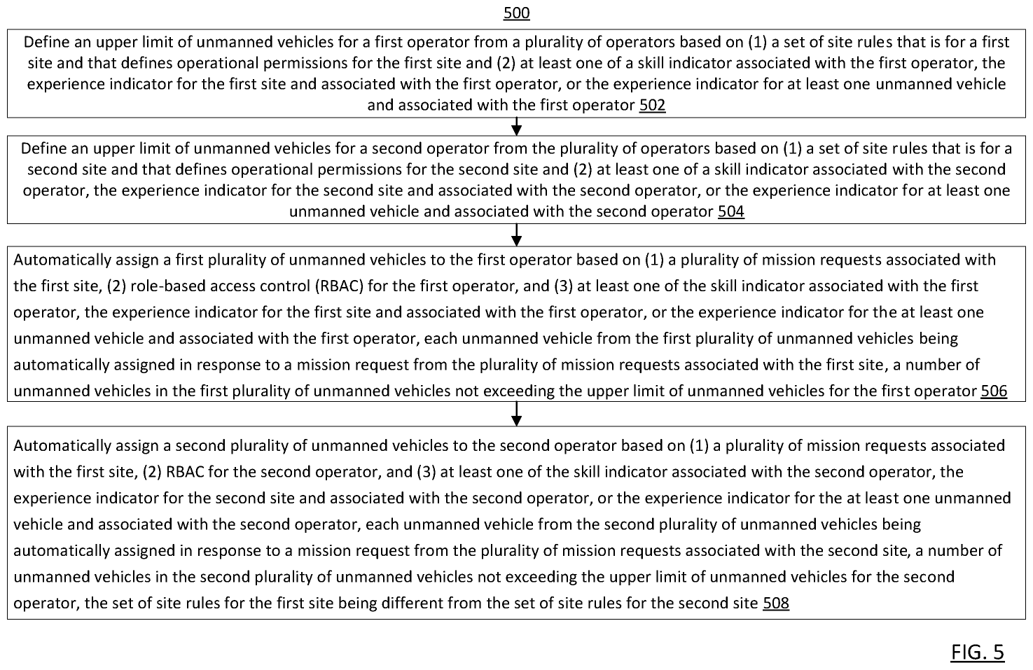

FIG. 5 show a flowchart of a method 500 to assign multiple unmanned vehicles different operators for different second sites having a different set of rules, according to an embodiment. In some implementations, method 500 is performed by a processor (e.g., processor 102).

At 502, an upper limit (e.g., to be included in set of operator site upper limits 109) of unmanned vehicles for a first operator (e.g., operator O1) from a plurality of operators (e.g., operators O1, O2, O3) is defined based on (1) a set of site rules (e.g., included in set of site rules 105) that is for a first site (e.g., site S1) and that defines operational permissions for the first site and (2) at least one of a skill indicator (e.g., included in set of operator skill indicators 106) associated with the first operator, the experience indicator (e.g., included in set of operator site experience indicators 107) for the first site and associated with the first operator, or the experience indicator (e.g., included in set of operator UV experience indicator 108) for at least one unmanned vehicle and associated with the first operator.

At 504, an upper limit (e.g., to be included in set of operator site upper limits 109) of unmanned vehicles for a second operator (e.g. operator O2) from the plurality of operators is defined based on (1) a set of site rules (e.g., included in set of site rules 105) that is for a second site (e.g., site S2) and that defines operational permissions for the second site and (2) at least one of a skill indicator (e.g., included in set of operator skill indicators 106) associated with the second operator, the experience indicator (e.g., included in set of operator site experience indicators 107) for the second site and associated with the second operator, or the experience indicator (e.g., included in set of operator UV experience indicators 108) for at least one unmanned vehicle and associated with the second operator.

At 506, a first plurality of unmanned vehicles is automatically (e.g., without human intervention) assigned to the first operator based on (1) a plurality of mission requests (e.g., included in set of mission requests 112) associated with the first site, (2) role-based access control (RBAC) (e.g., included in set of RBACs 111) for the first operator, and (3) at least one of the skill indicator associated with the first operator, the experience indicator for the first site and associated with the first operator, or the experience indicator for the at least one unmanned vehicle and associated with the first operator. Each unmanned vehicle from the first plurality of unmanned vehicles is automatically (e.g., without human intervention) assigned in response to a mission request from the plurality of mission requests associated with the first site. A number of unmanned vehicles in the first plurality of unmanned vehicles does not exceed the upper limit of unmanned vehicles for the first operator.

At 508, a second plurality of unmanned vehicles is automatically (e.g., without human intervention) assigned to the second operator based on (1) a plurality of mission requests (e.g., included in set of mission requests 112) associated with the first site, (2) RBAC for the second operator, and (3) at least one of the skill indicator associated with the second operator, the experience indicator for the second site and associated with the second operator, or the experience indicator for the at least one unmanned vehicle and associated with the second operator. Each unmanned vehicle from the second plurality of unmanned vehicles is automatically (e.g., without human intervention) assigned in response to a mission request from the plurality of mission requests associated with the second site. A number of unmanned vehicles in the second plurality of unmanned vehicles does not exceed the upper limit of unmanned vehicles for the second operator. The set of site rules for the first site can be different from the set of site rules for the second site.

In some implementations of method 500, automatically assigning the first plurality of unmanned vehicles to the first operator at 506 includes automatically assigning the first plurality of unmanned vehicles to the first operator further based on an availability (e.g., included in set of operator availabilities 110) of the first operator. In some implementations of method 500, automatically assigning the second plurality of unmanned vehicles to the second operator at 508 includes automatically assigning the second plurality of unmanned vehicles to the second operator further based on an availability (e.g., included in set of operator availabilities 110) of the second operator.

In some implementations of method 500, automatically assigning the first plurality of unmanned vehicles to the first operator at 506 includes automatically assigning the first plurality of unmanned vehicles to the first operator based on the set of site rules of the first site. In some implementations of method 500, automatically assigning the second plurality of unmanned vehicles to the second operator at 508 includes automatically assigning the second plurality of unmanned vehicles to the second operator further based on the set of site rules of the second site.

In some implementations of method 500, the mission request from the plurality of mission requests associated with the first site is a first mission request. Some implementations of method 500 further include receiving (e.g., from site compute device 140A) a registration request for a third operator (e.g., operator O3). Some implementations of method 500 further include defining an upper limit (e.g., to be included in set of operator site upper limits 109) of unmanned vehicles for the third operator from the plurality of operators based on the set of site rules for the first site. Some implementations of method 500 further include automatically assigning a third plurality of unmanned vehicles to the third operator based on the set of site rules for the first site. Each unmanned vehicle from the third plurality of unmanned vehicles is automatically assigned in response to a second mission request from the plurality of mission requests associated with the first site. A number of unmanned vehicles in the third plurality of unmanned vehicles does not exceed the upper limit of unmanned vehicles for the third operator and is different from the number of unmanned vehicles in the first plurality of unmanned vehicles.

All combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments and unless stated otherwise, the terms “about” “substantially” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

a. The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

1. A non-transitory processor-readable medium storing code representing instructions to be executed by a processor, the instructions comprising code to cause the processor to:
receive a registration request for an operator from a plurality of operators and for a site having a set of site rules defining operational permissions for the site, the operator associated with a skill indicator, an experience indicator for the site, and an experience indicator for at least one unmanned vehicle;
define, after the registration request of the operator is received, an upper limit of unmanned vehicles for the operator based on the set of site rules and at least one of the skill indicator associated with the operator, the experience indicator for the site and associated with the operator, or the experience indicator for the at least one unmanned vehicle and associated with the operator;
receive a plurality of mission requests associated with the site; and
automatically assign, after the receiving the plurality of mission requests, a plurality of unmanned vehicles to the operator based on the set of site rules, the experience indicator for the site and associated with the operator, and the experience indicator for the at least one unmanned vehicle and associated with the operator,
each unmanned vehicle from the plurality of unmanned vehicles being assigned in response to a mission request from the plurality of mission requests, a number of unmanned vehicles in the plurality of unmanned vehicles not exceeding the upper limit of unmanned vehicles for the operator.

2. The non-transitory medium of claim 1, wherein the operator is a first operator, the site is a first site included within a plurality of site, the plurality of unmanned vehicles is a first plurality of unmanned vehicles, the instructions further comprising code to cause the processor to:
automatically authorize the first operator for the first site and not for remaining sites from the plurality of sites;
receive a registration request for a second operator from the plurality of operators and associated with a second site that is from the plurality of sites and that has a set of site rules defining operational permission for the second site; and
automatically authorize, after the registration request for the second operator is received, the second operator for the second site from the plurality of sites and not remaining sites from the plurality of sites.

3. The non-transitory medium of claim 1, wherein the operator is a first operator, the instructions further comprising code to cause the processor to:
automatically assign a second plurality of unmanned vehicles to a second operator from the plurality of operators, a number of unmanned vehicles in the second plurality of unmanned vehicles not exceeding an upper limit of unmanned vehicles for the second operator,
the upper limit of unmanned vehicles for the first operator is different from the upper limit of unmanned vehicles for the second operator.

4. The non-transitory medium of claim 1, wherein the operator is a first operator, the site is a first site included within a plurality of sites, the plurality of unmanned vehicles is a first plurality of unmanned vehicles, the instructions further comprise code to cause the processor to:
receive a registration request for a second operator from the plurality of operators and associated with a second site that is from the plurality of sites and that has a set of site rules defining operational permission for the second site; and
automatically assign a second plurality of unmanned vehicles to the second operator, a number of unmanned vehicles in the second plurality of unmanned vehicles not exceeding an upper limit of unmanned vehicles for the second operator,
the set of site rules for the first site differing from set of site rules for the second site.

5. The non-transitory medium of claim 1, wherein the code to assign includes code to assign the plurality of unmanned vehicles to the operator further based on role-based access control (RBAC) for the operator and an availability of the operator.

6. The non-transitory medium of claim 1, wherein the site is included within a plurality of sites, the instructions further comprising code to cause the processor to:
automatically authorize, after receiving the registration request, the operator for the site and not for remaining sites from the plurality of sites,
the code to assign includes code to assign, after the operator has been authorized, the plurality of unmanned vehicles to the operator further based on role-based access control (RBAC) for the operator.

7. The non-transitory medium of claim 1, wherein the site is included within a plurality of sites, the instructions further comprising code to cause the processor to:
automatically authorize, after receiving the registration request, the operator for the site and not for remaining sites from the plurality of sites,
the code to assign includes code to assign, after the operator has been authorized, the plurality of unmanned vehicles to the operator during a time period when the operator is available to operate the plurality of unmanned vehicles.

8. The non-transitory medium of claim 1, wherein the operator is a first operator, the instructions further comprise code to cause the processor to:
receive an indication of communication failure between a compute device of the first operator and a first unmanned vehicle from the plurality of unmanned vehicles assigned to the first operator; and
automatically, in response to the receiving the indication of communication failure, reassign the first unmanned vehicle to a second operator based on an availability of the second operator and not based on an experience indicator for the site and associated with the second operator,
a number of unmanned vehicles assigned to the second operator after the first unmanned vehicles is reassigned to the second operator does not exceed an upper limit of unmanned vehicles for the second operator.

9. The non-transitory medium of claim 1, wherein the operator is a first operator, the instructions further comprise code to cause the processor to:
receive an indication of communication failure between a compute device of the first operator and each unmanned vehicle from the plurality of unmanned vehicles assigned to the first operator; and
automatically, in response to the receiving the indication of communication failure, reassign the plurality of unmanned vehicles to at least one operator other than the first operator based on an availability of the at least one operator and not based on an experience indicator for the site and associated with the at least one operator,
a number of unmanned vehicles assigned to each operator from the at least one operator after the plurality of unmanned vehicles are reassigned does not exceed an upper limit of unmanned vehicles for each operator from the at least one operator.

10. A method, comprising:
defining, at a processor, an upper limit of unmanned vehicles for a first operator from a plurality of operators based on (1) a set of site rules that is for a first site and that defines operational permissions for the first site and (2) at least one of a skill indicator associated with the first operator, the experience indicator for the first site and associated with the first operator, or the experience indicator for at least one unmanned vehicle and associated with the first operator;
defining, at the processor, an upper limit of unmanned vehicles for a second operator from the plurality of operators based on (1) a set of site rules that is for a second site and that defines operational permissions for the second site and (2) at least one of a skill indicator associated with the second operator, the experience indicator for the second site and associated with the second operator, or the experience indicator for at least one unmanned vehicle and associated with the second operator;
receiving, at the processor, a plurality of mission requests associated with the first site;
receiving, at the processor, a plurality of mission requests associated with the second site;
automatically assigning, at the processor, a first plurality of unmanned vehicles to the first operator based on (1) the set of site rules for the first site, and (2) at least one of a skill indicator associated with the first operator, the experience indicator for the first site and associated with the first operator, or the experience indicator for the at least one unmanned vehicle and associated with the first operator,
each unmanned vehicle from the first plurality of unmanned vehicles being automatically assigned in response to a mission request from the plurality of mission requests associated with the first site, a number of unmanned vehicles in the first plurality of unmanned vehicles not exceeding the upper limit of unmanned vehicles for the first operator; and
automatically assigning, at the processor, a second plurality of unmanned vehicles to the second operator based on (1) the set of site rules for the second site, and (2) at least one of a skill indicator associated with the second operator, the experience indicator for the second site and associated with the second operator, or the experience indicator for the at least one unmanned vehicle and associated with the second operator,
each unmanned vehicle from the second plurality of unmanned vehicles being automatically assigned in response to a mission request from the plurality of mission requests associated with the second site, a number of unmanned vehicles in the second plurality of unmanned vehicles not exceeding the upper limit of unmanned vehicles for the second operator,
the upper limit of unmanned vehicles for the first operator being different from the upper limit of the unmanned vehicles for the second operator.

11. The method claim 10, further comprising:
receiving, at the processor, a registration request for the first operator;
automatically authorizing, at the processor and after the registration request for the first operator is received, the first operator for the first site and not for remaining sites from the plurality of sites;
receiving, at the processor, a registration request for the second operator; and
automatically authorize, at the processor and after the registration request for the second operator is received, the second operator for the second site and not remaining sites from the plurality of sites.

12. The method of claim 10, wherein the set of site rules for the first site is different from the set of site rules for the second site.

13. The method of claim 10, wherein:
automatically assigning the first plurality of unmanned vehicles to the first operator includes automatically assigning the first plurality of unmanned vehicles to the first operator further based on role-based access control (RBAC) for the first operator; and
automatically assigning the second plurality of unmanned vehicles to the second operator includes automatically assigning the second plurality of unmanned vehicles to the second operator further based on RBAC for the second operator.

14. The method of claim 10, wherein:
automatically assigning the first plurality of unmanned vehicles to the first operator includes automatically assigning the first plurality of unmanned vehicles to the first operator further based on an availability of the first operator; and
automatically assigning the second plurality of unmanned vehicles to the second operator includes automatically assigning the second plurality of unmanned vehicles to the second operator further based on an availability of the second operator.

15. The method of claim 10, further comprising:
receiving, at the processor, a registration request for the first operator;
automatically authorizing, at the processor and after the registration request for the first operator is received, the first operator for the first site and not for remaining sites from the plurality of sites;
receiving, at the processor, a registration request for the second operator;
automatically authorizing, at the processor and after the registration request for the second operator is received, the second operator for the second site and not remaining sites from the plurality of sites;
automatically assigning the first plurality of unmanned vehicles to the first operator includes automatically assigning, after the first operator has been authorized, the first plurality of unmanned vehicles to the first operator further based on role-based access control (RBAC) for the first operator and an availability of the first operator; and
automatically assigning the second plurality of unmanned vehicles to the second operator includes automatically assigning, after the second operator has been authorized, the second plurality of unmanned vehicles to the second operator further based on role-based access control (RBAC) for the second operator and an availability of the second operator.

16. The method of claim 10, wherein the mission request from the plurality of mission requests associated with the first site is a first mission request, the method further comprising:
receiving, at the processor, a registration request for a third operator;
defining, at the processor, an upper limit of unmanned vehicles for the third operator from the plurality of operators based on the set of site rules for the first site; and
automatically assigning, at the processor, a third plurality of unmanned vehicles to the third operator based on the set of site rules for the first site, each unmanned vehicle from the third plurality of unmanned vehicles being automatically assigned in response to a second mission request from the plurality of mission requests associated with the first site, a number of unmanned vehicles in the third plurality of unmanned vehicles not exceeding the upper limit of unmanned vehicles for the third operator and being different from the number of unmanned vehicles in the first plurality of unmanned vehicles.

17. A non-transitory processor-readable medium storing code representing instructions to be executed by a processor, the instructions comprising code to cause the processor to:
define an upper limit of unmanned vehicles for a first operator from a plurality of operators based on (1) a set of site rules that is for a first site and that defines operational permissions for the first site and (2) at least one of a skill indicator associated with the first operator, the experience indicator for the first site and associated with the first operator, or the experience indicator for at least one unmanned vehicle and associated with the first operator;
define an upper limit of unmanned vehicles for a second operator from the plurality of operators based on (1) a set of site rules that is for a second site and that defines operational permissions for the second site and (2) at least one of a skill indicator associated with the second operator, the experience indicator for the second site and associated with the second operator, or the experience indicator for at least one unmanned vehicle and associated with the second operator;
automatically assign a first plurality of unmanned vehicles to the first operator based on (1) a plurality of mission requests associated with the first site, (2) role-based access control (RBAC) for the first operator, and (3) at least one of the skill indicator associated with the first operator, the experience indicator for the first site and associated with the first operator, or the experience indicator for the at least one unmanned vehicle and associated with the first operator,
each unmanned vehicle from the first plurality of unmanned vehicles being automatically assigned in response to a mission request from the plurality of mission requests associated with the first site, a number of unmanned vehicles in the first plurality of unmanned vehicles not exceeding the upper limit of unmanned vehicles for the first operator; and
automatically assign a second plurality of unmanned vehicles to the second operator based on (1) a plurality of mission requests associated with the first site, (2) RBAC for the second operator, and (3) at least one of the skill indicator associated with the second operator, the experience indicator for the second site and associated with the second operator, or the experience indicator for the at least one unmanned vehicle and associated with the second operator,
each unmanned vehicle from the second plurality of unmanned vehicles being automatically assigned in response to a mission request from the plurality of mission requests associated with the second site, a number of unmanned vehicles in the second plurality of unmanned vehicles not exceeding the upper limit of unmanned vehicles for the second operator,
the set of site rules for the first site being different from the set of site rules for the second site.

18. The non-transitory medium of claim 17, wherein:
the code to automatically assign the first plurality of unmanned vehicles to the first operator includes code to automatically assign the first plurality of unmanned vehicles to the first operator further based on an availability of the first operator, and
the code to automatically assign the second plurality of unmanned vehicles to the second operator includes code to automatically assign the second plurality of unmanned vehicles to the second operator further based on an availability of the second operator.

19. The non-transitory medium of claim 17, wherein:
the code to automatically assign the first plurality of unmanned vehicles to the first operator includes code to automatically assign the first plurality of unmanned vehicles to the first operator further based on the set of site rules of the first site, and
the code to automatically assign the second plurality of unmanned vehicles to the second operator includes code to automatically assign the second plurality of unmanned vehicles to the second operator further based on the set of site rules of the second site.

20. The non-transitory medium of claim 17, wherein the mission request from the plurality of mission requests associated with the first site is a first mission request, the instructions further comprise code to cause the processor to:
receive a registration request for a third operator;
define an upper limit of unmanned vehicles for the third operator from the plurality of operators based on the set of site rules for the first site; and
automatically assign a third plurality of unmanned vehicles to the third operator based on the set of site rules for the first site, each unmanned vehicle from the third plurality of unmanned vehicles being automatically assigned in response to a second mission request from the plurality of mission requests associated with the first site, a number of unmanned vehicles in the third plurality of unmanned vehicles not exceeding the upper limit of unmanned vehicles for the third operator and being different from the number of unmanned vehicles in the first plurality of unmanned vehicles.
